(19) United States
(12) Patent Application Publication
(10) Pub. No.: US 2026/0357626 A1
(43) Pub. Date: Nov. 12, 2026

(54) HINGE FOR A CONTAINER

(71) Applicant: ICEE HOLDINGS PTY LTD, Tullamarine, Victoria (AU)

(72) Inventors: Hamish HINGSTON, Tullamarine (AU); Sergio DE ALMEIDA, Tullamarine (AU); Derek JEFFERSON, Tullamarine (AU)

(73) Assignee: ICEE HOLDINGS PTY LTD, Tullamarine, Victoria (AU)

(21) Appl. No.: 19/131,805

(22) PCT Filed: Nov. 21, 2023
(86) PCT No.: PCT/AU2023/051185

§ 371 Date: May 21, 2025

(30) Foreign Application Priority Data
Nov. 21, 2022 (AU) 2022903520

(51) Int. Cl. E05D 7/10; E05D 5/04; E05D 5/10; E05D 5/14; E05D 9/00; E05D 11/08

(52) U.S. Cl. CPC E05D 7/1072; E05D 5/04; E05D 5/14; E05D 9/005; E05D 11/082; E05D 2005/106

(57) ABSTRACT

There is disclosed a hinge assembly for connecting panels made from an expandable material, comprising: a first hinge member having a first plate member configured to be positioned on a surface of one of the connecting panels and a first bottom plate configured to be embedded in the expandable material of the connecting panel; a second hinge member having a second plate member configured to be positioned on a surface of the other of the connecting panel and a second bottom plate configured to be embedded in the expandable material of the connecting panel; wherein the first plate member and the second plate member are configured to interengage to facilitate hinged movement of the connecting panels.

### RELATED APPLICATION(S)

The present application claims priority from earlier filed Australian Provisional Patent Application No. 2022903520 filed 21 Nov. 2023, the entire contents of which are incorporated herein by reference.

### FIELD OF INVENTION

The present invention relates generally to a hinge for a storage container, and in particular, to a hinge for a storage container formed from expandable material that is integrated into the expandable material.

### BACKGROUND OF THE INVENTION

Thermally insulated storage containers are generally used to provide a means for containing items in a controlled thermal environment for storage or transport. Such containers have a variety of different applications ranging from receiving foods, as well as medicines and the like, and for maintaining them in a controlled thermal environment to maximise their usable life. The controlled thermal environment could be a heated environment or a chilled environment, depending upon the item being stored in the container.

Conventional thermal insulated containers have generally been formed from a polymeric foam material, such as expanded polystyrene (EPS) or expanded polypropylene (EPP). Such materials have known thermal insulation properties and can be moulded in an efficient and cost effective manner to form a single three-dimensional container in a single piece. Such containers can then be used to store items, such as foodstuff, in a chilled or heated state, and lids can be fitted to the openings thereof to form an enclosed space within which the thermal environment can be retained for extended periods of time.

However, conventional single piece moulded containers have a number of disadvantages. One significant disadvantage is that they take up substantially the same volumetric space irrespective of whether they contain items or not. As such, when the containers are not in use, they require considerable storage space. This can be a considerable problem when the containers are used for transporting goods, as the containers require considerable storage space, even when empty. This can result in the containers being destroyed or disposed of, significantly minimising their usage life.

A number of attempts have been made to provide foldable containers that, when not in use, can be collapsed to significantly minimise the storage space required to store the containers. Such containers generally comprise panels having hinges formed therebetween to facilitate folding of the panels between the collapsed form and the assembled form. In containers made from an expandable material, such as Expanded Polystyrene (EPS) or Expanded Polypropylene (EPP), the ability to form such hinges within the body of the material has particular challenges, especially where such containers are intended for multiple use. Conventionally, such containers have been formed to create a region of reduced thickness between panels to form the hinge. However, in situations where the containers are to be assembled/reassembled multiple times, multiple use of the hinge may cause the material to fail at the hinge region substantially compromising the integrity of the container.

Thus, there is a need to provide a hinge arrangement for use in a container formed from expandable material that has sufficient strength to facilitate multiple folding cycles without compromising the integrity of the container.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### STATEMENT OF INVENTION

The invention according to one or more aspects is as defined in the independent claims. Some optional and/or preferred features of the invention are defined in the dependent claims.

Accordingly, in one aspect of the invention there is provided a hinge assembly for connecting panels made from an expandable material, comprising:
a first hinge member having a first plate member configured to be positioned on a surface of one of the connecting panels and a first bottom plate configured to be embedded in the expandable material of the connecting panel;
a second hinge member having a second plate member configured to be positioned on a surface of the other of the connecting panel and a second bottom plate configured to be embedded in the expandable material of the connecting panel;
wherein the first plate member and the second plate member are configured to interengage to facilitate hinged movement of the connecting panels.

In one embodiment, the first plate member and the first bottom plate and the second plate member and the second bottom plate are connected by rib members to facilitate integration of the hinge assembly with the expandable material.

At least one of the first hinge member and second hinge member may have a wing member extending laterally from at least one end thereof.

The wing member may be shaped to trap particles of the expandable material during expansion such that the particles of the expandable material fuse together in a space formed between the wing member and the end of the first or second hinge member.

At least one of the first plate member or second plate member may comprise a pin member and the other of the first plate member or second plate member may comprise one or more knuckles that fit over the pin member to interengage therewith.

The pin member may have a cam profile and the one or more knuckle members may engage with a surface of the cam profile of the pin member to control the angular position of the first plate member with respect to the second plate member.

In one form, the angular position of the first plate member with respect to the second plate member may vary between 0-90°.

In another form, the angular position of the first plate member with respect to the second plate member may vary between 0-270°.

The or each of the first or second hinge member may be formed from a polymeric material such that as the expandable material expands the expandable material will at least partially form a molecular bond with the polymeric material of the first or second hinge member.

The expandable material may be expanded polypropylene (EPP).

### BRIEF DESCRIPTION OF THE DRAWINGS

The invention may be better understood from the following non-limiting description of preferred embodiments, in which:

FIG. 1 is a perspective view of a container employing hinge assemblies in accordance with an embodiment of the present invention;

FIG. 2 and FIG. 3 show perspective views of a first hinge member and a second hinge member of the hinge assembly in accordance with the present invention.

FIG. 4 and FIG. 5 show side and perspective views of the assembled hinge assembly of the present invention in accordance with one embodiment;

FIG. 6 and FIG. 7 show top and rear views of the assembled hinge assembly of the present invention in accordance with another embodiment;

FIG. 8 is an end view of the assembled hinge assembly of the present invention in accordance with another embodiment;

FIG. 9-FIG. 11 shows a cross-sectional view of a hinge assembly in accordance with the present invention; and

FIG. 12 shows a cross-sectional view of a hinge assembly in accordance with the present invention.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention.

The present invention is intended for use in a container such as that disclosed in the Applicant's co-pending International PCT Patent Application No. PCT/AU2020/050491, the entire contents of which are incorporated herein by reference.

In this regard, the hinge arrangement of the present invention will be described below as being incorporated into a container formed from expanded polypropylene (EPP). However, it will be appreciated that the hinge arrangement of the present invention could be incorporated into a container formed from any variety of expandable materials, including other polymeric foam materials such as expanded polystyrene (EPS) or polyurethane, or any other plastic material capable of providing a thermal insulation.

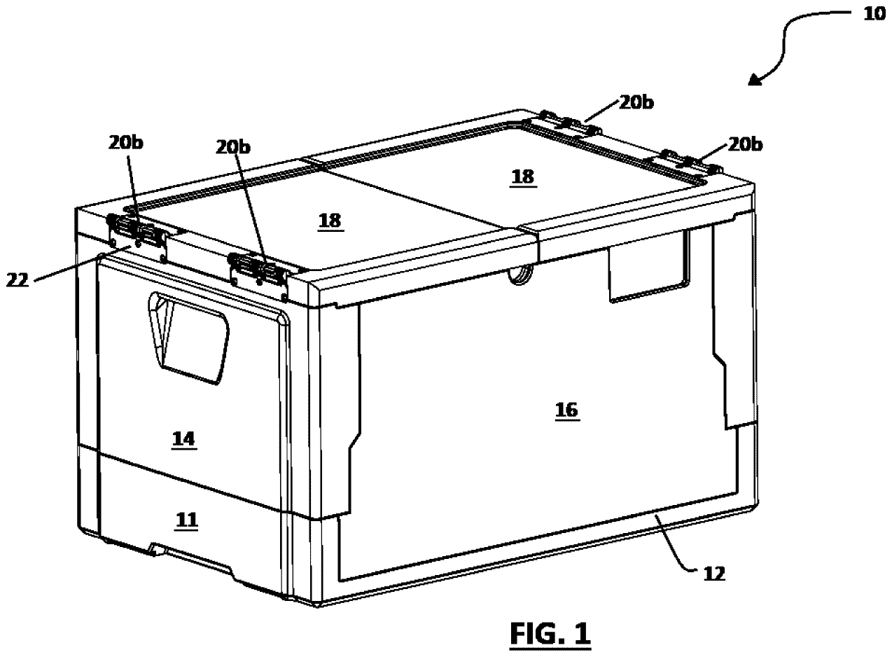

Referring to FIG. 1, a container 10 having the hinge assemblies 20 in accordance with an embodiment of the present invention is shown in an assembled form. The container 10 generally comprises a base 12, a pair of opposing end walls 14 and a pair of opposing side walls 16. In the embodiment as shown, lid members 18 are attached to an upper end of the end walls 14; however, in an alternative embodiment, the lid members may be attached to the upper end of the side walls 16. In another embodiment, the lid 18 may be a separate member fitted to the container 10 once assembled, or the container 10 may have no lid.

The base 12 is configured to comprise a pair of opposing end supports 11 that project from the base 12 in an upward manner. The end supports 11 extend across a width of the base 12 and are formed integral with the base 12. The end supports 11 support the end walls 14 thereon. The portion of the base 12 extending between the end supports 11 is a substantially planar surface that forms the bottom surface of the container 10 when the container is in the assembled form as shown.

The side walls 16 are each positioned to extend along an opposing side edge of the base 12. To facilitate folding of the container 10 into a collapsed configuration for storage, each side wall 16 is mounted to an opposing side edge of the base 12 by way of a base hinge assembly 20a of the present invention, which is concealed in FIG. 1. In this arrangement, the side walls 16 are folded inwardly to be supported one atop the other on the surface of the base 12.

The end walls 14 are mounted to the end supports 11 by way of a base hinge assembly 20a in accordance with the present invention, which is concealed in the embodiment of the invention depicted in FIG. 1. The base hinge assembly 20a provides a pivotal connection between a bottom edge of the end walls 14 and a top edge of the end supports 11. This orientation of the base hinge assembly 20a enables the end walls 14 to fold inwardly with respect to the container 10 in the same manner as side walls 16 and prevents the end walls 14 from being folded outwardly. It will be appreciated that due to the end supports 11 being substantially the same height as the combined thicknesses of the side walls 16, the end walls 14 will sit flush upon the surface of the side walls 16 when the container 10 is in the collapsed configuration. Further, as the combined height of the end walls 14 is less than the distance between the end supports 11, the end walls 14 can be folded to extend along the same plane and will not overlap.

In the embodiment of the container as shown, the lid members 18 are attached to the end walls 14 by way of lid hinge assemblies 20b. The lid hinge assemblies 20b and the base hinge assemblies 20a are similar in configuration but are configured differently to cater form different degrees of movement. As will be described below, the lid hinge assemblies 20b are configured to allow an arc of movement of approximately 270° of the lid member 18 with respect to the end walls 14. In comparison, the base hinge assemblies 20 a are configured movement through 180° but are restricted to be used with only 90° once overmolded and assembled to the base component. This restricts the end walls 14 and the side walls 16 from movement beyond the 90° required to be located in the disassembled state and the assembled state, as shown in FIG. 1.

With regard to the lid hinge assembly 20b, this assembly comprises a first hinge member 21 and a second hinge member 22. The upper edge of the end walls 14 have mounting projections formed thereon to which a hinge plate 23 of the first hinge member 21 is attached. The hinge plate 23 comprises a pin member 24 having a cam profile that projects vertically above the upper end of the end wall 14, as shown. The end of the lid member 18 has a hinge plate 25 of the second hinge member 22 mounted to an upper end thereof. The hinge plate 25 has knuckles 26 that project from the end of the lid member 18 to receive the pin member 24 of the first hinge member 21. In this arrangement, the hinge assembly 20 allows the lid member 18 to move through an arc of approximately 270°. This enables the lid members 18 to move between a closed position and an open position to facilitate access to the interior of the container 10.

Due to the 270° movement of the lid members 18 with respect to the end walls 14, when the container 10 is in the folded or collapsed position, the lid members 18 are able to be folded in a backwards manner with respect to the end walls 14. This ensures that the lid members 18 sit flush upon the outer surfaces of the respective end walls 14, thereby providing a compact folded container with the folded components each being supported by an underlying component with each component extending substantially parallel to each other. In such an arrangement the collapsed containers can be stored in a stacked manner that is both compact and stable.

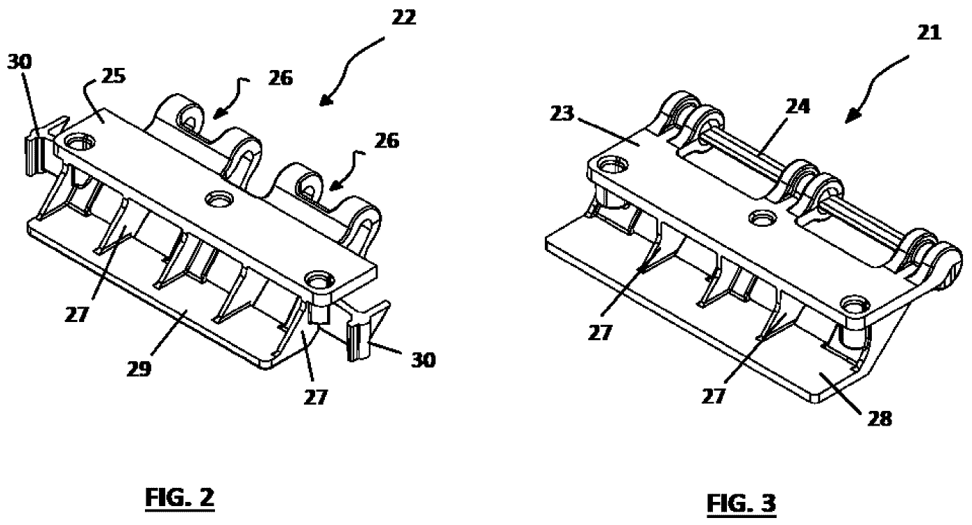

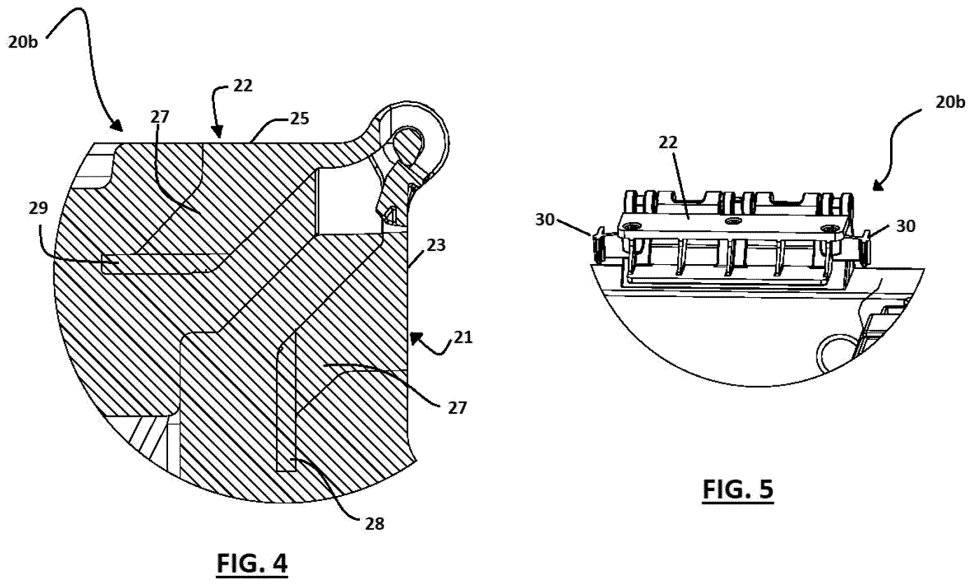

Referring to FIG. 2 and FIG. 3, the first hinge member 21 and the second hinge member 22 of lid hinge assemblies 20b are shown in isolation. Each of the first and second hinge members 21, 22 have a similar configuration and comprise a plurality of rib members 27 extending from an undersurface of the respective hinge plates 23, 25 which terminate at a first bottom hinge plate 28 and a second bottom hinge plate 29. As is best seen in FIG. 4, each of the rib members 27 extend in a downward manner and angularly away from the respective hinge plates 23, 25 such that the first bottom hinge plate 28 and the second bottom hinge plate 29 extend substantially parallel with the respective hinge plates 23, 25 but are laterally offset therefrom.

As discussed above, the components of the container 10 are preferably made of expandable material, such as EPP. The components of the base hinge assemblies 20a and the lid hinge assemblies 20b are made of a polymer that is preferably compatible with the expanded material such that during formation of the container 10, the hinge assemblies 20a, 20b are embedded within the expandable material such that the hinge assemblies 20a, 20b are bonded to the expandable material during the formation process. As the expanded material is moulded about the hinge assemblies 20a, 20b during the steam moulding cycle, there is a degree of molecular bonding of the hinge assemblies 20a, 20b with the expanded material during the overmoulding process. As the components of the hinge assemblies 20a, 20b are provided with voids formed between the rib members, as the material expands during the forming process, the expanding material will create an undercut with the hinge components thereby also forming a mechanical interlocking function or friction bond between the components of the hinge assemblies and the expandable material.

In this regard, as is depicted in FIG. 4 and FIG. 5, the first and second hinge members 21, 22 of the lid hinge assemblies 20b are configured such that rib members 27 and the bottom plates 28, 29 are encapsulated within the moulded material and trap the particles of the expandable material during the over-moulding process to create both a molecular bond from the steam heating process, and also a rigid mechanical or friction bond between the moulded foam and the rigid plastic material of the components of the lid hinge assemblies 20b. This creates a firm and robust engagement between the foam and the rigid components of the hinge assemblies 20a, 20b, that can withstand considerable forces during use of the container 10. As is shown, the first hinge member 21 and the second hinge member 22 are positioned within the mould such that the respective hinge plate 23 and hinge plate 25 are located adjacent an outer surface of the panel of the container 10.

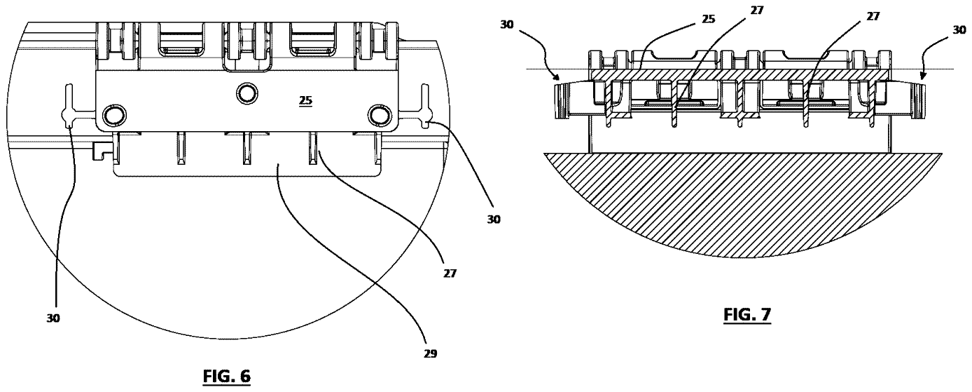

As is shown in FIG. 2, FIG. 6 and FIG. 7, the second hinge member 22 may also comprises a pair of retaining wing members 30 that extend laterally from opposing sides of the second hinge member 22. The retaining wing members 30 may function to trap the injected foam particles of the expandable material, such that during the steaming process the particles fuse in between the edge of the hinge member 22 and the wing member 30 to avoid separation occurring between the embedded hinge member and the expanded material when a bending force is applied to the container during use. This functions to avoid separation of the hinge assemblies and the container material during use which may form gaps and recesses therein where dirt, food and other matter can accumulate and compromise the safety and quality of the container 10.

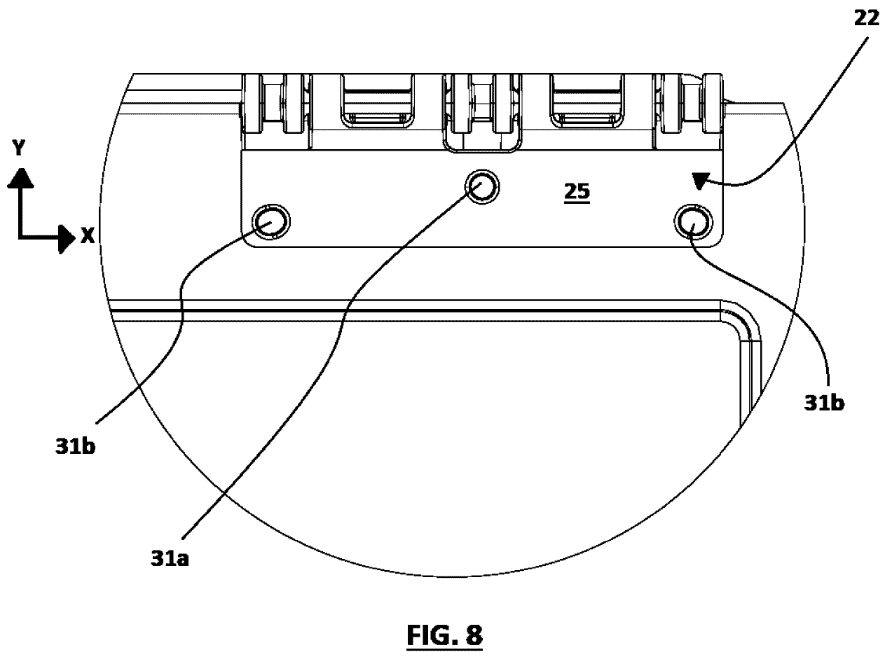

Referring to FIG. 8, a pin is provided to assist in locating the first hinge member for accurately positioning the hinge member 22 in a mould for overmoulding with the expandable material. In this regard, a pin is located in the holes 31a and 31b to provide an accurate position constraining the hinge member 22 from moving in the X and Y direction as shown. The round central hole 31a provides an accurate position for receiving a pin for constraining the hinge member from moving in the X and Y axis and the holes 31b formed in the surface of the hinge plate are elongated to allow for thermal expansion, contraction and warpage tolerances while accurately constricting rotation of the hinge member 22 around the Z-axis. The flat surface on the top of the hinge plate, in combination with the friction between the pins that are received in the hinge holes 31a and 31b constrains movement of the hinge member in the Z direction during the moulding process due to friction forces present when the mould is closing. Such an arrangement also facilitates the removal of the pins in the Z direction after over-moulding and during the transfer and ejection process. Using this system, the hinge members of the hinge assemblies 20a, 20b can be loaded into the mould both by human or by robot. It is also envisaged that clamps could be employed to attach to parts of the hinge members as the mould closes to prevent movement of the hinge member during the moulding process.

The hinge assemblies 20 are configured to provide clear margins for sealing between the expandable material to avoid the expandable beads entering undesired positions during formation. In this regard, the design of the first and second hinge members of each of the hinge assemblies 20a, 20b is such that all of the sealing surfaces can be positioned, such that core-pulls or other mechanisms are not required to remove sections of the mould from areas where foam is not intended to enter. The plastic material of the hinge members have been configured to ensure the particles of expandable material do not enter undesired areas that could cause the hinge members to collide with the expanded material during use, and not rotate correctly. The shape of the hinge members are optimised to allow particles of the expanded material to be injected in a normal manner and flow around the rigid hinge members. This also ensures that the expanded material is adequately thick (ie. several particle diameters across) in all areas to avoid inconsistent manufacturing, surface imperfections or poor fusion.

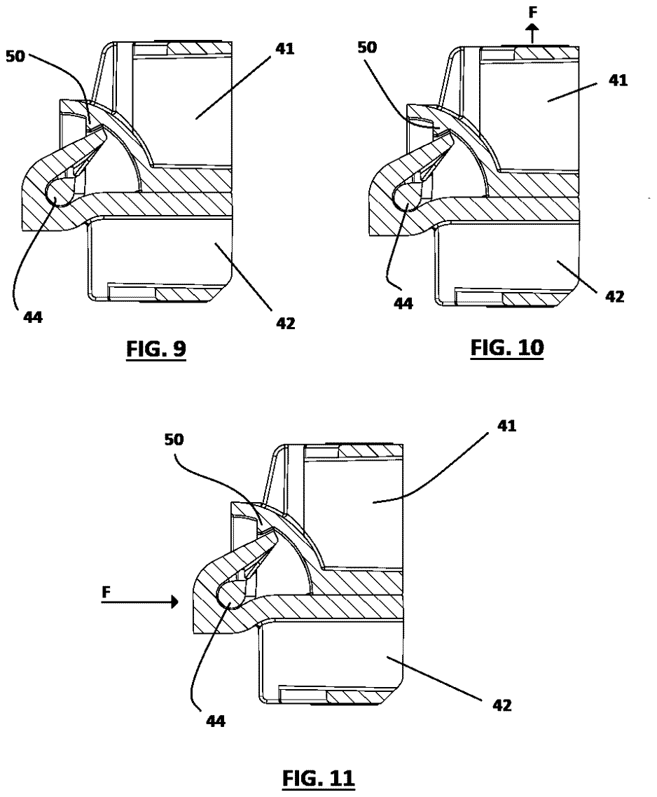

As previously discussed and as is shown in FIG. 9 and FIG. 10, the base hinge assembly 20a is depicted. the pin member 44 of the first hinge member 41 is configured with a cam profile. This cam profile of the pin member 44 works together with an upper rib 50 to resist any upward force from the upper panel member of the container 10, which would typically separate the two components of the container and create an air gap therebetween. Such an air gap would be detrimental to the temperature control performance of insulating container.

As is shown in FIG. 11, the hinge assemblies 20a, 20b have been configured to interlock when in their final position, as shown. This interlocking is caused by the engagement between the pin members 44 and the knuckles 46 that creates a strong connection between the two halves of the rigid hinge assemblies and reduces the loading of the foam-to-rigid plastic connection when a shear force is applied to the assembled container in the direction of arrow F.

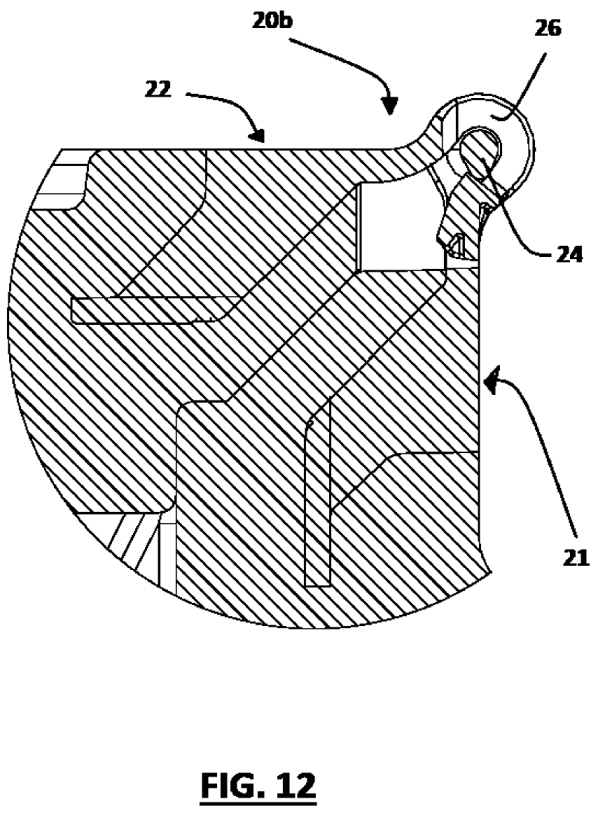

Referring to FIG. 12, the lid hinge assembly 20b is depicted. As is shown, the cam profile of the pin member 24 creates an interference with the knuckle 26 of the clip half of the hinge assembly, which performs a dual function: firstly, it functions to retain the light foam component of the container panels in the desired position; and secondly, it makes the first hinge member 21 and the second hinge member 22 of the hinge assembly 20b unlikely to separate by accidental means. In this regard, a tool is likely required to apply a considerable force to flex the knuckle 26, in order to separate the pin member 24 therefrom, thus ensuring the integrity of the container once assembled.

It will be appreciated that by providing a hinge assembly 20a, 20b in two parts, namely a first hinge member 21 and a second hinge member 22, each panel 11, 14, 16, 18 of the container 10 is able to be removed, and repaired and replaced if damaged. Such a two-part hinge assembly also allows for parts to be moulded in any configuration within the tooling as required.

It will be appreciated that the hinge assembly of the present invention is able to maintain the panels of the container 10 in the collapsed position, erected container position, and erected position with lids open for loading the container. The hinges for the lids are able to operate through more than 270 degrees of motion whilst the hinges for the base can move through 180 degrees but are restricted to be used with only 90 degrees of motion once overmolded and assembled to the base component. All other configurations are also possible within the range of the hinges allowed movement. The hinges are ideally compatible with the foam material being used for the over-moulding process, but it is not necessarily required due to the mechanical interlocking design of the rigid hinges and the moulded particles. Additives and other materials can be used to provide further enhancing properties like heat resistance etc.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the container uppermost.

It will be appreciated by those skilled in the art that many modifications and variations may be made to the methods of the invention described herein without departing from the spirit and scope of the invention.

1. A hinge assembly for connecting panels made from an expandable material, comprising:
a first hinge member having a first plate member configured to be positioned on a surface of one of the connecting panels and a first bottom plate configured to be embedded in the expandable material of the connecting panel;
a second hinge member having a second plate member configured to be positioned on a surface of the other of the connecting panel and a second bottom plate configured to be embedded in the expandable material of the connecting panel;
wherein the first plate member and the second plate member are configured to interengage to facilitate hinged movement of the connecting panels.

2. A hinge assembly according to claim 1, wherein the first plate member and the first bottom plate and the second plate member and the second bottom plate are connected by rib members to facilitate integration of the hinge assembly with the expandable material.

3. A hinge assembly according to claim 2, wherein at least one of the first hinge member and second hinge member have a wing member extending laterally from at least one end thereof.

4. A hinge assembly according to claim 3, wherein the wing member is shaped to trap particles of the expandable material during expansion such that the particles of the expandable material fuse together in a space formed between the wing member and the end of the first or second hinge member.

5. A hinge assembly according to claim 1, wherein one of the first plate member or second plate member comprises a pin member and the other of the first plate member or second plate member comprises one or more knuckles that fit over the pin member to interengage therewith.

6. A hinge assembly according to claim 5, wherein the pin member has a cam profile and the one or more knuckle members engage with a surface of the cam profile of the pin member to control the angular position of the first plate member with respect to the second plate member.

7. A hinge assembly according to claim 6, wherein the angular position of the first plate member with respect to the second plate member may vary between 0-90°.

8. A hinge assembly according to claim 6, wherein the angular position of the first plate member with respect to the second plate member may vary between 0-270°.

9. A hinge assembly according to claim 1, wherein each of the first or second hinge member is formed from a polymeric material such that as the expandable material expands the expandable material will at least partially form a molecular bond with the first or second hinge member

10. A hinge assembly according to claim 1, wherein the expandable material is expanded polypropylene (EPP).
